(19) United States
(12) Patent Application Publication
(10) Pub. No.: US 2022/0204189 A1
(43) Pub. Date: Jun. 30, 2022

(54) SPACECRAFT RADIATION SHIELD SYSTEM

(71) Applicant: Space Talos Ltd., London (GB)

(72) Inventor: Majed Abdel JAWAD, London (GB)

(73) Assignee: Space Talos Ltd., London (GB)

(21) Appl. No.: 17/263,512

(22) PCT Filed: Jul. 5, 2019
(86) PCT No.: PCT/GB2019/051916

§ 371 Date: Jan. 26, 2021

(30) Foreign Application Priority Data
Jul. 24, 2018 (GB) 1812074.1

(51) Int. Cl. B64G 1/54; H01F 7/02

(52) U.S. Cl. CPC B64G 1/546; H01F 7/0226

(57) ABSTRACT

A spacecraft radiation shield system (2) is disclosed for improving the protection from ionising radiation from the external environment and providing an improved freedom of orientation to the spacecraft. The spacecraft radiation shield system includes: at least two magnets arranged in a magnetic multipole (6), a magnetometer (14), and an adjustable magnet (10). The magnetometer (14) is configured to measure the magnetic field experienced at the spacecraft, and the magnetic field orientation of the adjustable magnet (10) is controlled in response to the measured magnetic field thereby controlling the direction and magnitude of the overall dipole moment of the system

The present invention relates to a spacecraft radiation shield system, and a technique for improving orientation control for spacecraft while achieving protection from ionising radiation from the external environment.

Spacecraft, such as satellites and space stations, can be subjected to high energy radiation from the sun, which can lead to the damage of electronic equipment on board. Satellites in low earth orbits can be protected from this radiation, to some extent, by the earth's magnetic field. However, techniques are required to protect satellites in medium earth orbits or in geosynchronous orbits where the earth's magnetic field is weaker. Techniques are also required to protect low earth satellites in polar orbits where the Earth's magnetic field offers little protection. Known radiation shield systems include passive shielding techniques, where metallic layers are used to surround the electronics, electrostatic shielding techniques such as a Faraday cage, and plasma shielding techniques, where a mass of ionised particles is entrapped by an electromagnetic field and used to deflect or ensnare incoming charged particles. This mass of entrapped ionised particles may be known as a plasma shock barrier. Earth's magnetosphere is a form of plasma shielding.

To create the magnetic fields used in plasma shielding techniques in spacecraft, single magnetic dipole configurations have typically been used to mimic and align with Earth's magnetosphere. The interaction between the magnetic dipole of a spacecraft plasma shield with Earth's magnetic field in this way can also help orient and stabilise a spacecraft. However, this interaction can present difficulties when a mission objective or desired direction of spacecraft travel requires that the spacecraft points in a particular direction because the Earth's magnetosphere effectively locks a spacecraft with a magnetic dipole to a single orientation in which the magnetic dipole is aligned with the Earth's magnetic field lines.

Rotating a spacecraft's magnetic dipole out of line from Earth's magnetosphere could cause significant oscillatory movement of the spacecraft. In order to counter the oscillatory movement, hysteresis rods could be used to dampen the oscillations and convert the rotational energy into heat energy. However, this introduces a separate set of complications in a spacecraft which are also undesirable.

A single dipole plasma shield configuration can also leave a spacecraft vulnerable to incoming radiation, or incident charged particles, that is or are parallel to the dipole moment. The optimum shielding direction of a magnetic field is at a point furthest away from a magnet along a magnetic field flux line. In a single dipole system this would be along a plane at the centre of the dipole, perpendicular to the dipole moment.

An object of the invention is to improve the protection of spacecraft radiation shield systems, and provide the spacecraft an improved freedom of orientation.

According to an aspect of the invention there is provided a spacecraft radiation shield system, comprising: at least two magnets arranged in a magnetic multipole so that, in the absence of any external magnetic field, the magnets provide no overall dipole moment; a magnetometer configured to measure the magnetic field experienced at the spacecraft in three orthogonal directions; at least one adjustable magnet that can provide a magnetic field with a controllable orientation; and a control system configured to send control signals to the adjustable magnet in order to control its magnetic field orientation in response to the magnetic field detected by the magnetometer in order to control the direction and magnitude of the overall dipole moment of the system.

In this way it is possible for a spacecraft radiation shield system to provide shielding from ionising radiation in all directions. The magnetic multipole arrangement means that no overall dipole moment is exhibited when there is no external magnetic field experienced by the at least two magnets. However, the addition of an external magnetic field, created at a plasma shock barrier may alter the overall magnetic field of the system. Without correction, this may provide a dipole moment in a direction that is influenced by the magnitude and direction of the external magnetic field. The magnetometer is configured to measure the magnetic field experienced at the spacecraft in three orthogonal directions such that the control system can send control signals to the adjustable magnet, where the adjustable magnet can provide a magnetic field with a controllable direction. In this way, the adjustable magnet can control the size and direction of the overall magnetic field of the system. The adjustable magnet may be configured to provide an overall magnetic field with no dipole moment. Alternatively, the adjustable magnet may receive control signals that orient it such that a small overall dipole moment is provided in a desired direction; this can allow the spacecraft to be oriented in a desirable attitude where the dipole moment of the spacecraft is aligned with the Earth's magnetic field lines. Therefore the spacecraft radiation shield system allows the spacecraft to orient itself in any desirable attitude with respect to any magnetic fields experienced from the external environment.

Preferably the at least one adjustable magnet is an electromagnet. In this way it may be possible for the control system to vary the intensity, or magnitude, of the magnetic field by varying the electric current supplied to the electromagnet. An electromagnet may be a simple adjustable magnetic source, without any moving parts, for use in a spacecraft.

Preferably the adjustable magnet comprises at least three electromagnets arranged in three orthogonal directions. In this way it is possible for each electromagnet to be controlled individually by the control system in response to the measurements of the magnetometer. For example the control system may provide at least three control signals to each of the at least three electromagnets such that the magnetic fields provided by each of the electromagnets can be adapted to produce a desirable direction and magnitude of the overall dipole moment of the system. By using at least three electromagnets the spacecraft radiation system can be provided with no moving parts, which is particularly desirable in a spacecraft since moving parts may be difficult or impossible to fix if they become faulty. Preferably the three electromagnets are arranged in the same three directions of measurement of the magnetometer such that each electromagnet may be controlled directly in response to a corresponding magnetometer measurement of the same orthogonal direction. In an alternative arrangement the electromagnets may be arranged in different respective directions to the orthogonal axes of the magnetometer.

The at least one adjustable magnet may be rotatable about two orthogonal axes. In this way it is possible to use a single adjustable magnet. The control system can cause the magnet to be rotated to a desirable orientation in response to the magnetic field detected by the magnetometer such that the orientation of the magnetic field of the adjustable magnet controls the direction and magnitude of the overall dipole moment of the system. The rotatable magnet may be an electromagnet or a permanent magnet.

Preferably the magnetometer and the at least one adjustable magnet are provided in a position relative to the at least two magnets in the multipole at which the magnetic flux density is substantially negligible. In this way the magnetometer and the at least one adjustable magnet can be positioned in an effective neutral zone. This allows the magnetometer to measure any external magnetic field without any effect of the magnetic field of the at least two magnets in the multipole. This may improve the sensitivity of the magnetometer.

In one arrangement the magnets in the magnetic multipole may be moveable relative to one another. One or more motors may be provided to achieve this effect. In this way the optimum shielding direction of the radiation shield system can be adjusted in response to changes in the orientation of the spacecraft or changes in the flow or direction of incoming ionised particle flow/ionising radiation. By varying the distance between the magnets, the angles and the shape of the magnetic field of the at least two magnets is also varied such that the optimum shielding direction of the magnetic field (which is when the magnetic field flux distance is furthest to the magnets and perpendicular to the incoming radiation) can be directed toward the incoming radiation.

The at least two magnets in the multipole may be electromagnets. In this way the optimum shield direction of the radiation shield system can be adjusted by varying the electric currents supplied to the at least two magnets. By varying the electric currents, the angles and the shape of the magnetic field of the at least two magnets can also be varied such that the optimum shielding direction of the magnetic field can be directed toward the incoming radiation. Electromagnets may be preferred so that the magnets can be switched off during sensitive operations of the spacecraft or during launch where a magnetically neutral payload may be required.

The at least two magnets in the multipole may be permanent magnets. In this way the permanent magnets can provide the magnetic sources for the radiation shield without an electric current supply, which may be advantageous in a spacecraft where power resources are limited.

The magnetic multipole may comprise any even number of magnets, greater than two. In preferred embodiments the magnetic arrangement may comprise a quadrupole or an octupole.

The at least two magnets in the multipole and the at least one adjustable magnet may be combined in a magnetic multipole arrangement comprising six electromagnets, which are individually adjustable. In this way the six electromagnets provide a flexible arrangement which allows each electromagnet to be individually controlled to produce a desired magnetic field.

According to another aspect of the invention there is provided a method of generating a spacecraft radiation shield comprising: providing at least two magnets arranged in a magnetic multipole so that, in the absence of any external magnetic field, the magnets provide no overall dipole moment; measuring, using a magnetometer, the magnetic field experienced at the spacecraft in three orthogonal directions; sending the magnetometer measurements to a control system; processing the magnetometer measurements at the control system; and sending, using the control system, control signals to at least one adjustable magnet in order to control the direction to control the direction and magnitude of the overall dipole moment of the system, wherein the adjustable magnet can provide a magnetic field with a controllable orientation.

Preferably the method further comprises: receiving user instructions at the control system, wherein the user instructions provide information on a desired direction and magnitude of the overall dipole moment of the system; and processing the user instructions at the control system.

Preferably the method further comprises: sending, using the control system, control signals to adjust the relative positions of the at least two magnets in the multipole; and in response to the control signals, moving the magnets so that their separation distance is changed.

According to another aspect of the invention there is provided a computer program product comprising memory comprising instructions which when executed by one or more processors in a spacecraft radiation shield system, cause the spacecraft radiation shield system to: measure, using a magnetometer, the magnetic field experienced at the spacecraft in three orthogonal directions; send the magnetometer measurements to a control system; process the magnetometer measurements at the control system; and send, using the control system, control signals to at least one adjustable magnet in order to control the direction to control the direction and magnitude of the overall dipole moment of the system, wherein the adjustable magnet can provide a magnetic field with a controllable orientation, and wherein the system comprises at least two magnets arranged in a magnetic multipole so that, in the absence of any external magnetic field, the magnets provide no overall dipole moment.

Embodiments of the invention and now described, by way of example, with reference to the drawings, in which:

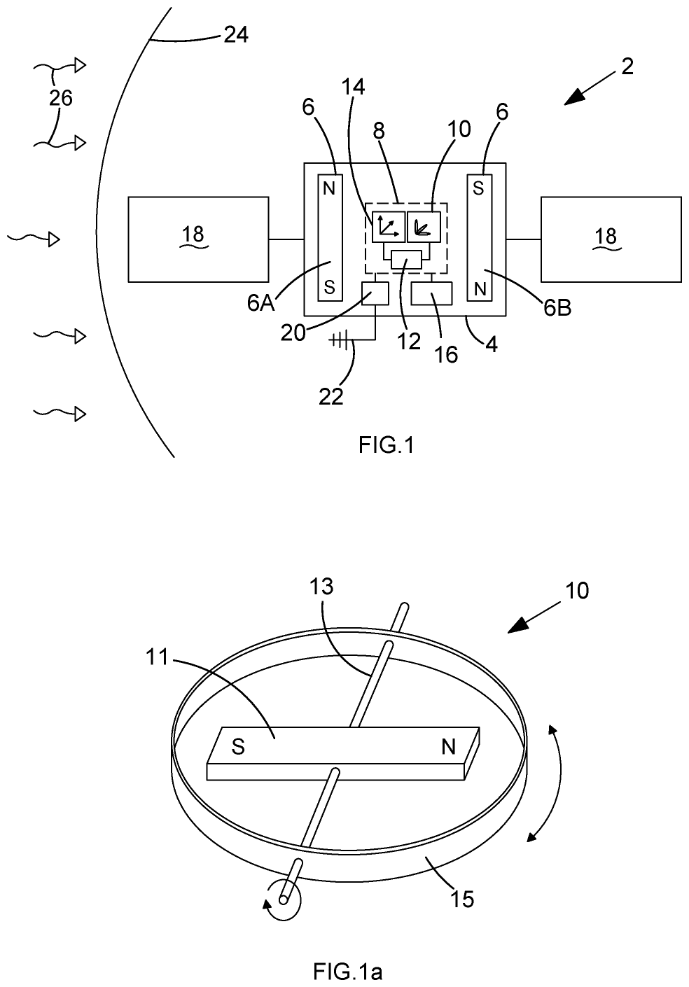

FIG. 1 is a schematic view of a spacecraft with a spacecraft radiation shield system in an embodiment of the present invention;

FIG. 1a is a schematic view of an adjustable magnet unit in another arrangement;

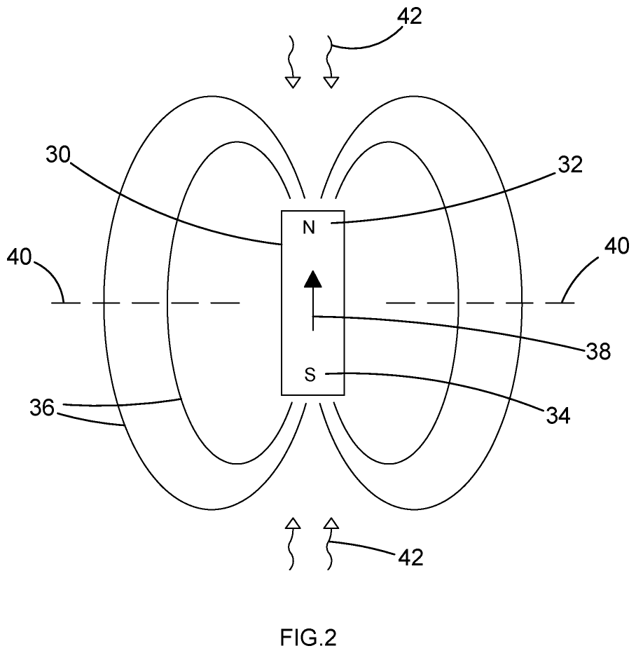

FIG. 2 is a schematic view of a dipole magnetic arrangement;

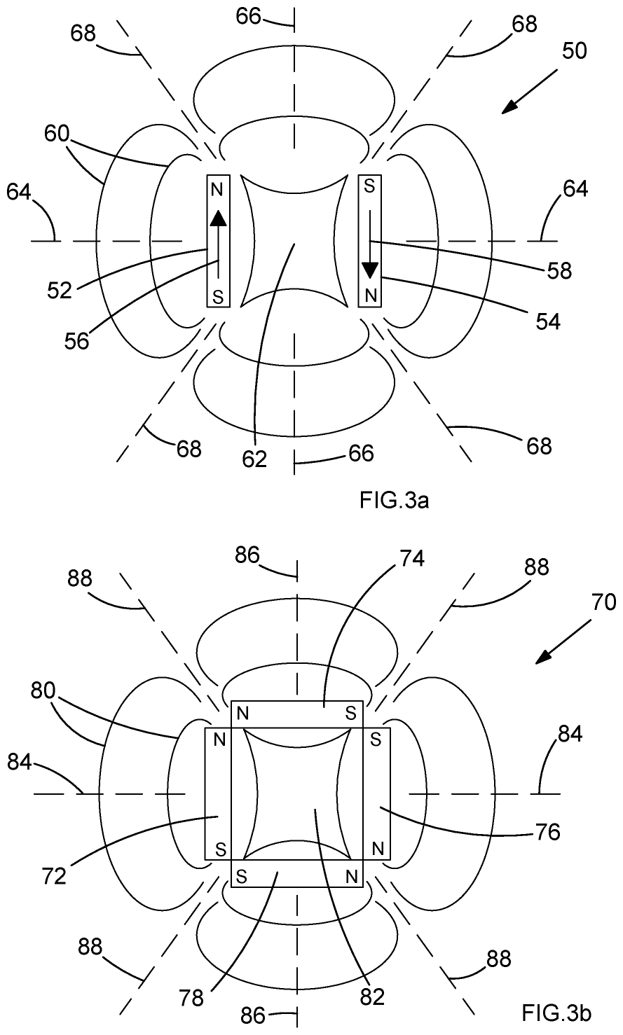

FIG. 3a is a schematic view of a quadrupole magnetic arrangement;

FIG. 3b is a schematic view of another quadrupole magnetic arrangement;

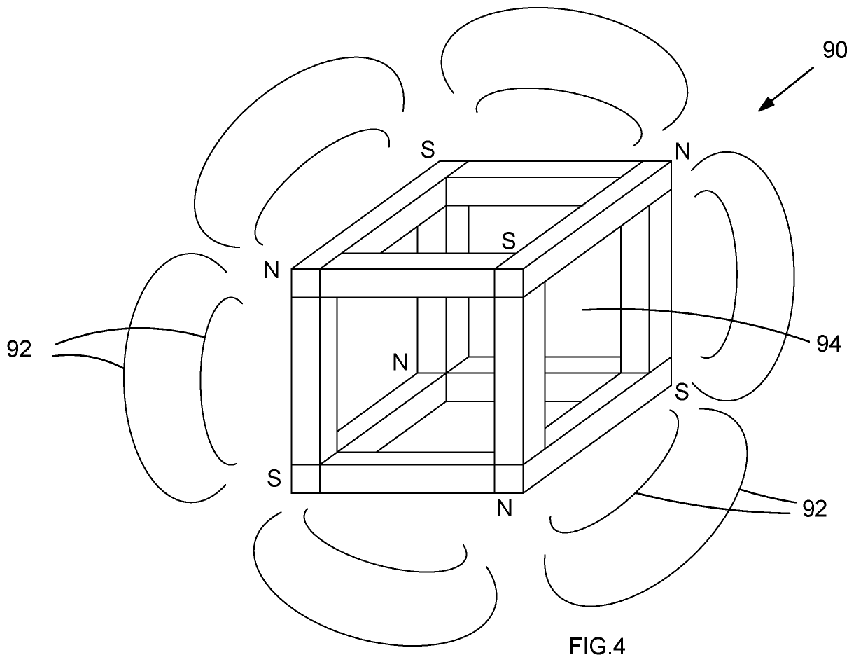

FIG. 4 is a schematic view of an octupole magnetic arrangement;

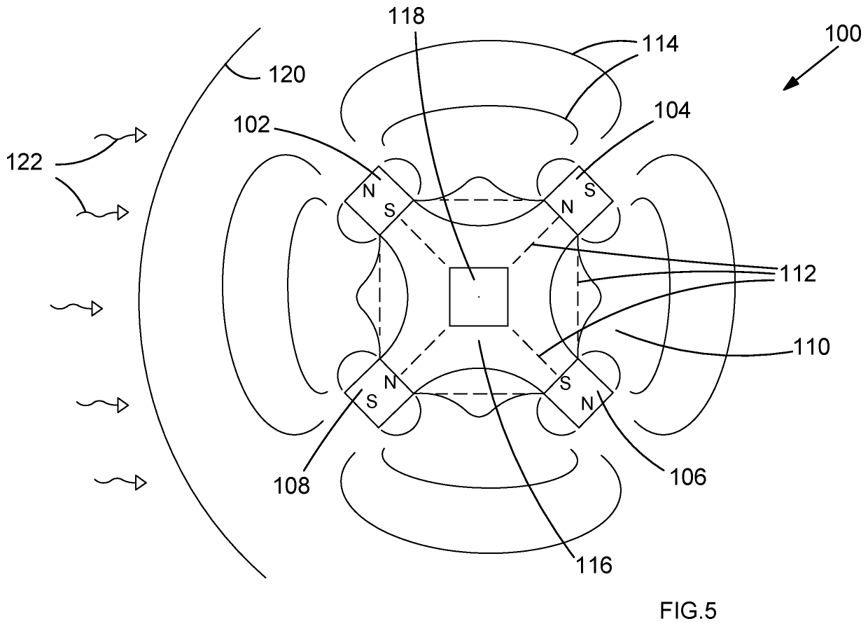

FIG. 5 is a schematic view of a spacecraft radiation shield system in another embodiment of the invention;

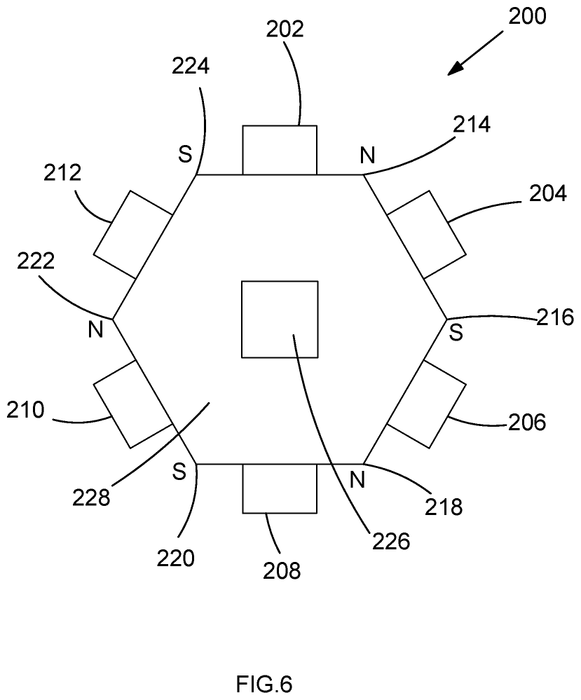

FIG. 6 is a schematic view of a spacecraft radiation shield system in another embodiment of the invention; and

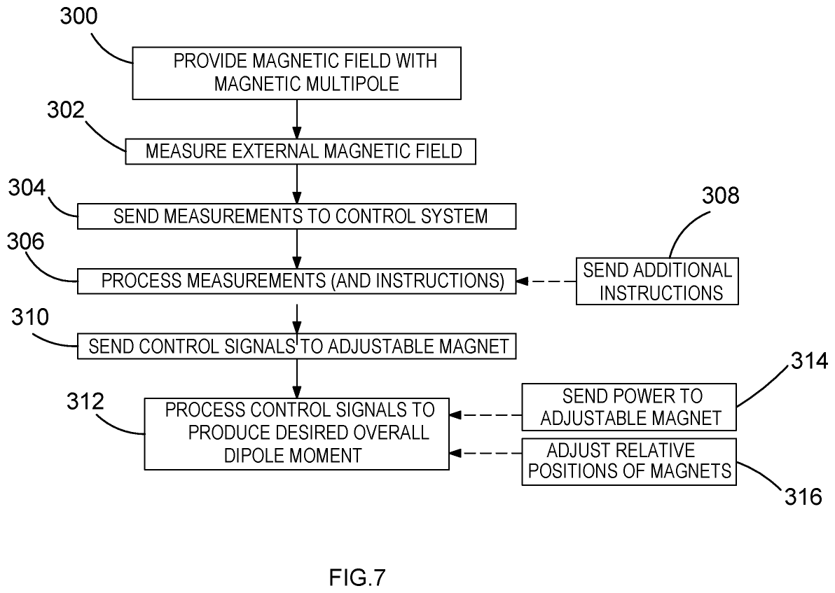

FIG. 7 is a flow diagram showing steps taken in a method of generating a spacecraft radiation shield, in an embodiment of the invention.

FIG. 1 is a schematic view of a spacecraft 2 in outer space. A satellite is depicted in this example, but the techniques described herein are equally applicable to other kinds of spacecraft. The spacecraft 2 has a spacecraft radiation shield system 4 including a magnetic multipole 6 comprising a first magnet 6A and a second magnet 6B. The first magnet 6A and the second magnet 6B have respective North poles and South poles. The first magnet 6A is positioned at a first extreme edge of a body of the spacecraft 2 such that the North pole of the first magnet 6A is provided at an upper corner of the first extreme edge and the South pole of the first magnet 6A is provided at a lower corner of the first extreme edge. The second magnet 6B is positioned parallel to the first magnet 6A at a second extreme edge, at the opposite end of the spacecraft body, in an inverted orientation such that the North pole of the second magnet 6B is provided at a lower corner of the second extreme edge and the South pole of the second magnet 6B is provided at an upper corner of the second extreme edge. The arrangement of the first magnet 6A and the second magnet 6B forms a magnetic quadrupole, which has a magnetic field as shown in FIG. 3a. FIG. 3a shows magnetic field lines 60 which represent the directions of magnetic force of the magnetic quadrupole 50, and a magnetic neutral zone 62 located within an interior region of the magnetic quadrupole 50. The magnetic neutral zone 62 is where the dipole terms of the individual magnets in the quadrupole cancel out resulting in an area where the magnetic flux density is substantially negligible.

With reference to FIG. 1, a magnetic field weak zone is located within an interior region of the magnetic multipole 6, i.e. between the first magnet 6A and the second magnet 6B, and provides an area in the centre of the spacecraft 2 that is free from any magnetic effects. It is within the magnetic field neutral zone of the spacecraft 2 that a control module 8 of the spacecraft radiation shield system 4 is located. The spacecraft radiation shield system 4 is designed such that the magnetic field neutral zone is located at or near the centre of gravity of the spacecraft 2.

The control module 8 comprises magnetically-sensitive instruments, including an adjustable magnet unit 10, a control system 12, and a magnetometer 14. The control module 12 receives power from a power controller 16, which in turn receives power from energy received from solar panels 18 and/or batteries on the spacecraft 2. The control module 12 is also connected to a communications module 20, which receives communication signals from an antenna 22 on the spacecraft or from command systems on board the spacecraft 2.

In this example embodiment, the adjustable magnet unit 10, or vector magnet, has three electromagnets arranged in three orthogonal directions, where each electromagnet can be individually controlled to produce a magnetic field in a particular orientation/around the orthogonal direction which the electromagnet is arranged. The adjustable magnet unit 10 is configured to draw power from the power controller 16 and produce a magnetic field in a desired orientation by controlling the relative strength of the magnetic fields of each of the three orthogonal electromagnets. The adjustable magnet unit 10 provides an orientable magnetic field in response to control signals that are received from the control system 12. The strength of the magnetic field of the adjustable magnet unit 10 can also be controlled by varying the current supply to the adjustable magnet unit 10.

The control system 12, which includes one or more processors, sends control signals to the adjustable magnet unit 10 in response to data received from the magnetometer 14 and/or the communications module 20. The magnetometer 14 is configured to measure the magnetic field experienced at the spacecraft 2 in three orthogonal directions and to send measurement data to the control system 12. The control system 12 can also receive instructions from the communications module 20, which may provide information on the desired magnetic orientation of the adjustable magnet unit 10. The communications module 20 may receive its instructions from a mission control centre via the receiving antenna 22, or from a flight deck in the spacecraft 2.

The magnetometer 14 is configured to measure the overall direction, strength and/or relative change of the magnetic field experienced at the spacecraft 2 by measuring the relative strength of the magnetic field in three orthogonal directions. The spacecraft 2 may be situated within the Earth's magnetic field, or magnetosphere, which approximately has the field of a magnetic dipole as shown in FIG. 2. A single magnetic dipole 30 has a North pole 32 and a South pole 34, and a dipole moment 38 with a direction which points from the South pole 34 to the North pole 32. The magnetic force of the single magnetic dipole 30 acts in the directions as represented by magnetic field lines 36 from the North pole 32 to the South pole 34. If the spacecraft 2 is under the magnetic influence of the Earth's dipole-like magnetic field then the magnetometer 14 would measure the direction and strength of the Earth's magnetic field relative to the position and orientation of the spacecraft 2. To measure the external magnetic field the magnetometer 14 is configured to measure the magnetic field in three orthogonal directions relative to the orientation of the spacecraft 2. Another example of an external magnetic field, which can be detected by the magnetometer 14, is an electromagnetic field created by a plasma shock barrier 24 (when incoming radiation 26 is diverted by the magnetic field of the magnetic multipole 6 and results in a collection of electric fields, forming the plasma shock barrier 24).

The magnetic multipole 6 is designed so that it has no overall dipole moment (as can be seen in FIG. 3a) when the spacecraft 2 does not experience any external magnetic field effects. By having no overall dipole moment the orientation of the spacecraft 2 would not be influenced by the Earth's dipole-like magnetic field, for example. This would allow the spacecraft 2 to orient itself freely and adopt any desirable attitude. However the magnetic field of the multipole 6 can be distorted by an external magnetic field such that the spacecraft 2 does exhibit a dipole moment when external magnetic fields are taken into account. Without correction, this effective dipole moment could cause the orientation of the spacecraft 2 to align undesirably with the direction of the external magnetic force. The spacecraft radiation shield system 4 provides a means to correct the effective dipole moment in the spacecraft 2 by producing a magnetic field to compensate for the distortion effects, or to provide an additional magnetic component so that a magnetic dipole moment is established for the spacecraft 2 in a chosen direction.

The magnetometer 14 measures the magnetic field experienced at the spacecraft 2 so that the distortion of the magnetic field of the multipole 6, and a direction and strength of a possible dipole of the spacecraft 2 can be determined. The control system 12 receives the measurements data from the magnetometer 14, and based on predetermined instructions or instructions received from the communications module 20 determines a desired magnetic field direction for the adjustable magnet unit 10 so that the spacecraft 2 exhibits no overall dipole moment or a dipole moment with a desired direction and magnitude. In order to produce the magnetic field to complement or compensate the external magnetic field effects the control system 12 sends control signals, produced following the determination of the required magnetic field, to the adjustable magnet unit 10. In response to receiving the control signals the adjustable magnet unit 10 provides a magnetic field in the desired orientation and magnitude, thereby allowing the spacecraft radiation shield system 4 to control the direction and magnitude of the overall dipole moment of the system. The adjustable magnet unit 10 provides the magnetic field in a desired direction by adjusting the relative strength of the magnetic fields in three electromagnets that are disposed around three orthogonal axes.

In addition to the orientation control provided by the spacecraft radiation shield system 4, the system also provides increased directional shielding from ionising radiation. By arranging the magnetic multipole 6 at the extreme ends of the spacecraft 2, the magnetic flux (and radiation shielding properties) is maximised outside of the spacecraft 2. As will be appreciated by a person skilled in the art, the optimum shielding direction of a magnetic field is at a point furthest away from a magnet along a magnetic field flux line.

From FIG. 2 it can be understood that a plasma shield with a dipole configuration has regions of vulnerability in directions parallel to the dipole moment 38, where incoming radiation 42 toward the single magnetic dipole 30 would not be blocked by the magnetic field of the single magnetic dipole 30. An optimum shielding direction 40 of the single magnetic dipole 30 is along a plane at the centre of the dipole, perpendicular to the dipole moment 38. Therefore by providing the spacecraft radiation shield system 4 that has no overall dipole moment (in the absence of external magnetic field effects), the multipole 6 provides two optimum shield directions, which can be understood from FIG. 3a where the magnetic quadrupole 50 provides a first optimum shielding direction 64 and a second optimum shielding direction 66.

As will be appreciated by a person skilled in the art, the first and second optimum shielding directions and in a quadrupole such as that shown in FIG. 1 can be changed by varying the distance between the first magnet and the second magnet. In the case where the first magnet and second magnet are electromagnets, the optimum shielding directions can also be altered by varying the current supplied to the electromagnets.

Therefore the control system 12 can also provide control signals to the adjustable magnet unit 10 in order to align an optimum shielding direction with incoming radiation 26 as well as providing the orientation control described above. In another embodiment, the spacecraft radiation shield system 4 further includes motors within the magnetic multipole 6 which can be operated so that each of the magnets in the multipole can be individually moved to control the shape of the spacecraft's magnetic field. Alternatively the spacecraft 2 may be positioned, free from any orientation lock from environmental magnetism, to align the optimum shielding direction with incoming radiation 26.

In another arrangement, as shown in Figure la, the adjustable magnet unit 10 is a single magnet 11 (which may be a permanent magnet or an electromagnet) having a North pole and a South Pole, where the single magnet 11 is mounted on an orientation system. The orientation system comprises a rod 13 on which the single magnet 11 is held, and a circular frame 15, where the rod 13 is held at two opposite points around the circumference of the frame 15.

The length of the rod 13 is in the same plane as the circular face of the circular frame 15. The rod 13 is rotatable around its longitudinal axis, which in turn would rotate the single magnet 11 around a first axis, and the circular frame 15 can be turned around a second axis (which in connectedly allows the single magnet 11 to be rotated about the second axis). Therefore the orientation system allows the single magnet 11 to be rotated about two orthogonal axes. Motors are provided in the orientation system that can be operated to cause the rod 13 and/or the circular frame 15 to move in the ways described. The orientation system is controlled via control signals received from the control system 12 in order to rotate the single magnet 11 to a desirable orientation.

Various modifications of the invention will be readily apparent to those skilled in the art. In particular the magnetic multipole of spacecraft radiation shield system requires magnet arrangements that have no overall dipole moment in the absence of an external magnetic field. Different arrangements of magnetic multipoles are provided in FIGS. 3a, 3b and 4, which can be implemented into the spacecraft radiation shield system in FIG. 1. In addition, as will be appreciated by a person skilled in the art, the magnets within the multipole may be permanent magnets, bitter electromagnets or superconducting magnets according to the requirements of the spacecraft in which they are positioned.

FIG. 2 shows a single magnetic dipole 30 with a North pole 32 and a South pole 34. Magnetic field lines 36 represent directions of the magnetic force of the single magnetic dipole 30. The single magnetic dipole 30 has a dipole moment 38 with a direction which points from the south pole 34 to the north pole 32. An optimum shielding direction 40 of a single magnetic dipole 30 is along a plane at the centre of the dipole, perpendicular to the dipole moment 38. The single magnetic dipole 30 would provide zero or limited shielding against incident radiation in a direction 42 parallel to the dipole moment 38.

FIG. 3a shows a magnetic quadrupole 50 consisting of a first magnet 52 and a second magnet 54 inversely positioned parallel to one another such that the direction of a dipole moment 56 of the first magnet 52 is the opposite of the direction of the direction of a dipole moment 58 of the second magnet 54. Magnetic field lines 60 represent directions of magnetic force of the magnetic quadrupole 50, and a magnetic neutral zone 62 is located within an interior region of the magnetic quadrupole 50 where the dipole terms of the first magnet 52 and the second magnet 54 cancel out. The magnetic quadrupole 50 provides a first optimum shielding direction 64 and a second optimum shielding direction 66. The magnetic quadrupole 50 would provide a weaker degree of radiation shielding in directions 68, but as there is no dipole moment in those directions 68 shielding effects would still be exhibited.

FIG. 3b shows another magnetic quadrupole 70 consisting of a first magnet 72, a second magnet 74, a third magnet 76 and a fourth magnet 78 arranged in a square shape. The magnets 72, 74, 76 and 78 each have a North pole and a South pole, where the North poles of the first magnet 72 and second magnet 74 meet at a first corner of the square, the South poles of the second magnet 74 and third magnet 76 meet at a second corner, the North poles of the third magnet 76 and fourth magnet 78 meet at a third corner, and the South poles of the fourth magnet 78 and the first magnet 72 meet at a fourth corner. Magnetic field lines 80 represent directions of magnetic force of the magnetic quadrupole 70, and a magnetic neutral zone 82 is located within an interior region of the magnetic quadrupole 70 where the dipole terms of the magnets 72, 74, 76 and 78 cancel out. The magnetic quadrupole 70 provides a first optimum shielding direction 84 and a second optimum shielding direction 86. Directions 88 indicate where radiation shielding is weaker.

The arrangement of magnetic quadrupole 70 can be implemented in the spacecraft of FIG. 1 where the first magnet 72 and third magnet 76 take the positions of the first magnet 6A and second magnet 6B, and the second magnet 74 and the fourth magnet 78 are positioned at an upper extreme end and a lower extreme end of the spacecraft body to form the square shape as shown in FIG. 3b.

FIG. 4 shows a magnetic octupole 90 consisting of twelve magnets arranged along the twelve edges of a cube. Each of the twelve magnets has a North pole and a South pole, and the magnets are arranged such that either the North poles or the South poles of meeting magnets come together to result in a single pole, North or South, being provided at each of the eight vertices of the cube. Magnetic field lines 92 of represent directions of magnetic force of the magnetic octupole 90, and a magnetic neutral zone 94 is located within an interior region of the magnetic octupole 90 where dipole terms of the twelve magnets cancel out.

FIG. 5 shows a spacecraft radiation shield system 100 in another embodiment of the invention. The spacecraft radiation shield 100 has four electromagnetic coils 102, 104, 106 and 108 arranged at respective corners of a square shape to form a magnetic quadrupole 110. Each of the electromagnetic coils 102, 104, 106 and 108 has a North pole and a South pole. The first electromagnetic coil 102 is diagonally positioned at a first corner of the square shape such that the North pole of the first electromagnet coil 102 is outwardly directed away from the square and the South pole of the first electromagnet coil 102 is directed toward a centre point in the middle of the square. The second electromagnetic coil 104 is diagonally positioned at a second corner of the square shape such that the North pole of the second electromagnet coil 104 is directed toward a centre point in the middle of the square and the South pole of the second electromagnet coil 104 is outwardly directed away from the square. The third electromagnetic coil 106 is positioned at a third corner of the square and arranged in a similar way to the first electromagnetic coil 102 (where the North pole points away from the square and the south pole points toward the middle of the square), and the fourth electromagnetic coil 108 is positioned at a fourth corner of the square. The magnetic multipole 110 has no overall dipole moment when the system 100 does not experience at external magnetic field effects. The four electromagnetic coils 102, 104, 106 and 108 are mounted on a set of tracks 112 to move individual positions of the coils, and motors are provided within the magnetic quadrupole 110.

Magnetic field lines 114 represent the directions of magnetic force of the magnetic quadrupole 110, and a magnetic neutral zone 116 is located within an interior region of the magnetic quadrupole 110 where the dipole terms of the electromagnetic coils 102, 104, 106 and 108 cancel out. A control module 118 is positioned in the magnetic neutral zone 116, where the control module 118 comprises magnetically-sensitive instruments, including a magnetometer, a control system and an adjustable magnet unit (not shown). A spacecraft should be designed such that the magnetic field neutral zone 116 of radiation shield system 100 is located at the centre of gravity of the spacecraft.

The control module 118 is configured to provide an orientable magnetic field using an adjustable magnetic unit and/or the operable motors within the magnetic quadrupole 110, in response to magnetic field of the environment, measured by the magnetometer, and/or incident radiation toward the spacecraft. The control module 118 can also receive data from a mission control centre or a flight deck in the spacecraft.

A plasma shock barrier 120 is formed when incoming radiation 122 (for example from the Sun) is diverted by the magnetic field of the magnetic quadrupole 110. The plasma shock barrier 120 creates an electromagnetic field that influences the overall dipole moment of the system 100 to exhibit a dipole moment. The control module 118 operates to respond to an external magnetic field to allow the spacecraft radiation shield system 100 to control the orientation and magnitude of the overall dipole moment of the system.

FIG. 6 shows a spacecraft radiation shield system 200 in another embodiment of the invention. The spacecraft radiation shield system has six electromagnet coils 202, 204, 206, 208, 210, 212 each having North and South poles arranged in a sextupole magnetic multipole arrangement, where each electromagnet is positioned along each of the six sides of a hexagon shape such that alternating North or South poles are provided at each corner of the hexagon. In other words the North poles of the first electromagnet 202 and the second electromagnet 204 are provided at a first corner 214 of the hexagon, the South poles of the second electromagnet 204 and the third electromagnet 206 are provided at a second corner 216 of the hexagon, the North poles of the third electromagnet 206 and the fourth electromagnet 208 are provided at a third corner 218 of the hexagon, the South poles of the fourth electromagnet 208 and the fifth electromagnet 210 are provided at a fourth corner 220 of the hexagon, the North poles of the fifth electromagnet 210 and the sixth electromagnet 212 are provided at a fifth corner 222 of the hexagon, and the South poles of the sixth electromagnet 212 and the first electromagnet 202 are provided at a sixth corner 224 of the hexagon. The system 200 has no overall dipole moment when there is no external magnetic influence.

In this embodiment each of the magnets in the magnetic multipole are electromagnets and the current supplied (from a power controller) to each electromagnet is individually adjustable. The spacecraft radiation shield system 200 further includes motors within the magnetic multipole which can be operated so that each of the electromagnets in the multipole can be individually moved to control the shape of the spacecraft's magnetic field. It should be understood that the adjustable magnet(s) described in other embodiments of the invention is part of the magnetic multipole in this embodiment of the spacecraft radiation shield system 200.

A control module 226 is positioned in a central zone 228, where the control module 226 comprises magnetically-sensitive instruments, including a magnetometer and control system. A spacecraft should be designed such that the central zone 228 of the radiation shield system 200 is located at the centre of gravity of the spacecraft.

In response to an external magnetic field, the control module 226 individually controls each of the electromagnets 202, 204, 206, 208, 210, 212 by adjusting the relative positions of the magnets and/or controls the current supplied to each individual electromagnet in order to generate a desired magnetic field.

Alternative configurations of arranging magnets (permanent magnets and/or electromagnets) to provide magnetic multipoles with no overall dipole moment in the absence of an external magnetic field would readily occur to a person skilled in the art.

FIG. 7 is a flow diagram showing a sequence of steps undertaken to generate a spacecraft radiation shield. At step 300 the magnetic multipole 6 provides a magnetic field which exhibits no overall dipole moment in the absence of an external magnetic field. At step 302 the magnetometer 14 measures the magnetic field experienced at the spacecraft 2 in three orthogonal directions. The magnetometer 14 sends its measurements to the control system 12 at step 304.

At step 306 the control system 16 analyses the measurements received from the magnetometer 14 and determines the control signals to be sent to the adjustable magnet unit 10. Step 308 may be included where additional instructions, from a user, may be sent to the control system 12 to be processed. The additional instructions may be for the system 4 to provide a particular orientation and/or magnitude of the overall dipole moment of the system that is in line with the travel or trajectory of a spacecraft, or may be to provide a magnetic field that compensates for any magnetic distortion caused by an external magnetic field. In another example the additional instructions may be to orient an optimum shielding direction of the system toward any incident charged particles.

At step 310 the control signals are sent from the control system 12 to the adjustable magnet unit 10. The control signals provide information to the adjustable magnet unit 10 to generate a magnetic field. The adjustable magnet unit 10 uses three electromagnets and the information may include the current to be supplied to each individual electromagnet. Alternatively if the adjustable magnet unit uses an orientation system to rotate a single magnet, the information may also include the orientation to which the single magnet is to be rotated.

At step 312 the adjustable magnet unit 10 processes the control signals and provides a magnetic field in a particular orientation, whereby the effect of the magnetic field generated by the adjustable magnet unit 10 is combined the magnetic field experienced at the spacecraft 2 to produce a desired overall dipole moment, or no overall dipole moment, of the system 4. Step 314 may be included where the electromagnets draw power from the power controller 16.

Step 316 may also be included where control signals are sent to the control module 8 to adjust the relative positions of the magnetic multipole 6 and thus the optimum shielding direction of the system 4.

Other embodiments will be apparent to those skilled in the art from consideration of the specification and practice of the embodiments disclosed herein. It is intended that the specification and examples be considered as exemplary only.

1. A spacecraft radiation shield system, comprising:
at least two magnets arranged in a magnetic multipole so that, in the absence of any external magnetic field, the magnets provide no overall dipole moment;
a magnetometer configured to measure the magnetic field experienced at the spacecraft in three orthogonal directions;
at least one adjustable magnet that can provide a magnetic field with a controllable orientation; and
a control system configured to send control signals to the adjustable magnet in order to control its magnetic field orientation in response to the magnetic field detected by the magnetometer in order to control the direction and magnitude of the overall dipole moment of the system.

2. The spacecraft radiation shield system of claim 1, wherein the at least one adjustable magnet is an electromagnet.

3. The spacecraft radiation shield system of claim 2, wherein the adjustable magnet comprises at least three electromagnets arranged in three orthogonal directions.

4. The spacecraft radiation shield system of claim 1, wherein the at least one adjustable magnet is rotatable about two orthogonal axes.

5. The spacecraft radiation shield system of any of the preceding claims, wherein the magnetometer and the at least one adjustable magnet are provided in a position relative to the at least two magnets in the multipole at which the magnetic flux density is substantially negligible.

6. The spacecraft radiation shield system of claim 1, wherein the magnets in the magnetic multipole are moveable relative to one another, and wherein the movement of magnets in the multipole is controlled by signals from the control system.

7. The spacecraft radiation shield system of any of the preceding claims, wherein the at least two magnets in the multipole are electromagnets.

8. The spacecraft radiation shield system of any of claims 1 to 6, wherein the at least two magnets in the multipole are permanent magnets.

9. The spacecraft radiation shield system of claim 1, wherein the at least two magnets in the multipole and the at least one adjustable magnet are comprised within a magnetic multipole arrangement including six electromagnets.

10. A method of generating a spacecraft radiation shield comprising:
providing at least two magnets arranged in a magnetic multipole so that, in the absence of any external magnetic field, the magnets provide no overall dipole moment;
measuring, using a magnetometer, the magnetic field experienced at the spacecraft in three orthogonal directions;
sending the magnetometer measurements to a control system;
processing the magnetometer measurements at the control system;
sending, using the control system, control signals to at least one adjustable magnet in order to control the direction and magnitude of the overall dipole moment of the system, wherein the adjustable magnet can provide a magnetic field with a controllable orientation.

11. The method of claim 10 further comprising:
receiving user instructions at the control system, wherein the user instructions provide information on a desired direction and magnitude of the overall dipole moment of the system; and
processing the user instructions at the control system.

12. The method of claim 10 further comprising:
sending, using the control system, control signals to adjust the relative positions of the at least two magnets in the multipole; and
in response to the control signals, moving the magnets so that their separation distance is changed.

13. A computer program product comprising memory comprising instructions which when executed by one or more of the processors of a spacecraft radiation shield system, cause the spacecraft radiation shield system to:
measure, using a magnetometer, the magnetic field experienced at the spacecraft in three orthogonal directions;
send the magnetometer measurements to a control system;
process the magnetometer measurements at the control system; and
send, using the control system, control signals to at least one adjustable magnet in order to control the direction and magnitude of the overall dipole moment of the system, wherein the adjustable magnet can provide a magnetic field with a controllable orientation, and wherein the system comprises at least two magnets arranged in a magnetic multipole so that, in the absence of any external magnetic field, the magnets provide no overall dipole moment.
